(19) United States
(12) Patent Application Publication
(10) Pub. No.: US 2008/0035065 A1
(43) Pub. Date: Feb. 14, 2008

(54) Combined Bird Feeder and Squirrel Feeder

(76) Inventor: Lauren Grace Towner, Pittsburgh, PA (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(21) Appl. No.: 11/740,470

(22) Filed: Apr. 26, 2007

Related U.S. Application Data
(60) Provisional application No. 60/795,311, filed on Apr. 27, 2006.

(51) Int. Cl. A01K 39/00

(52) U.S. Cl. 119/57.8; 119/51.01

(57) ABSTRACT

A combined feeder for both birds and squirrels is disclosed. One part of the feeder may be filled with birdseed, while the other part of the feeder may be filled with squirrel food. In one embodiment, squirrels are prevented from eating the birdseed.

### CROSS-REFERENCE TO RELATED APPLICATION

This application claims the benefit of U.S. Provisional Application No. 60/795,311 filed Apr. 27, 2006, which is incorporated herein by reference.

### FIELD OF THE INVENTION

The present invention relates to animal feeders, and more particularly relates to combined bird and squirrel feeders.

### BACKGROUND INFORMATION

Many types of bird feeder designs are known. However, squirrels often eat the birdseed. Several bird feeder designs only let birds eat the birdseed and try to keep squirrels out.

U.S. Pat. Nos. 4,541,362, 5,309,867, 5,676,089, 5,720,238, 5,921,201, 6,561,128, 6,584,932, 6,591,781 and 6,918,353, which are incorporated herein by reference, disclose various types of squirrel-proof bird feeders. In each of these designs, birds can perch and eat the birdseed, but the weight of a squirrel will close the feeder to prevent access by the squirrel.

U.S. Pat. Nos. 5,361,723, 5,490,480, 6,269,771 and 6,604,487, which are incorporated herein by reference, disclose other types of bird feeders with means for preventing squirrels from gaining access to birdseed contained in the feeder.

U.S. Pat. Nos. 5,664,522 and 6,951,188 disclose feeders designed to tease squirrels that attempt to gain access to the feeders.

### SUMMARY OF THE INVENTION

The invention provides a combined feeder for both birds and squirrels. One part of the feeder may be filled with birdseed, while the other part of the feeder may be filled with squirrel food. In one embodiment of the invention, squirrels are prevented from eating the birdseed.

An aspect of the present invention is to provide a combined bird feeder and squirrel feeder comprising a bird feed compartment structured and arranged to hold bird feed and to allow birds access to the bird feed, and a squirrel feed compartment adjacent to the bird feed compartment structured and arranged to hold squirrel feed and to allow squirrels access to the squirrel feed.

Another aspect of the present invention is to provide a combined bird feeder and squirrel feeder comprising a bird feed compartment including means for feeding birds from the bird feed compartment, and a squirrel feed compartment including means for feeding squirrels from the squirrel feed compartment.

These and other aspects of the present invention will be more apparent from the following description.

### BRIEF DESCRIPTION OF THE DRAWINGS

FIG. 1 is a partially schematic side view of a combined bird feeder and squirrel feeder in accordance with an embodiment of the present invention.

FIG. 2 is a partially schematic side view of a combined bird feeder and squirrel feeder in accordance with another embodiment of the present invention.

### DETAILED DESCRIPTION

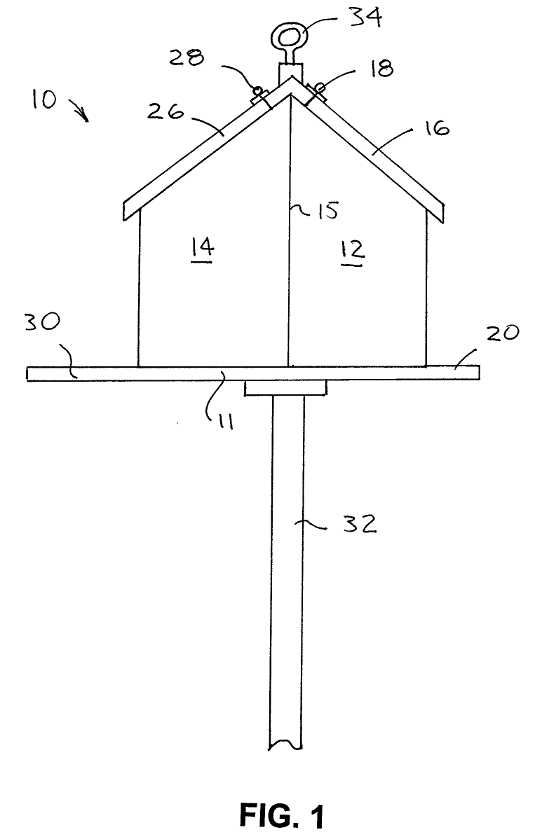

FIG. 1 shows a combined bird and squirrel feeder 10 having a base 11, a bird feed compartment 12, and a squirrel feed compartment 14. The base 11 forms the floor of the bird feed compartment 12 and the squirrel feed compartment 14. The bird and squirrel feed compartments 12 and 14 are separated by a vertical divider wall 15. On the bird feeder side, a roof 16 may be opened by a hinge 18. A bird ledge 20 is provided on the bird feeder side to allow birds to perch while they are eating the birdseed. On the squirrel feeder side, a roof 26 may be opened by a hinge 28. The roof may cover both of the bird and squirrel feed compartments 12 and 14 as shown in FIG. 1. Alternatively, the roof may cover only one of the compartments, e.g., the squirrel feed compartment 14 may be uncovered. A squirrel ledge 30 is provided on the squirrel feeder side to allow the squirrels to stand or sit while eating the squirrel food from the squirrel side 14 of the feeder. The feeder 10 may be mounted on a pole 32, or may be hung from a hook 34.

The bird feed compartment 12 may be filled with any type of birdseed, such as sunflower seeds, millet, corn, and the like. The squirrel feed compartment 14 may be filled with any desired type of squirrel food, such as nuts, sunflower seeds, and the like. In accordance with an embodiment of the present invention, different types of feed are provided in the bird and squirrel feed compartments. For example, smaller food such as sunflower seeds and millet may be provided for the birds, while larger food such as nuts may be provided for the squirrels. Thus, the average seed or particle size of the bird feed may be less than the average seed or particle size of the squirrel feed.

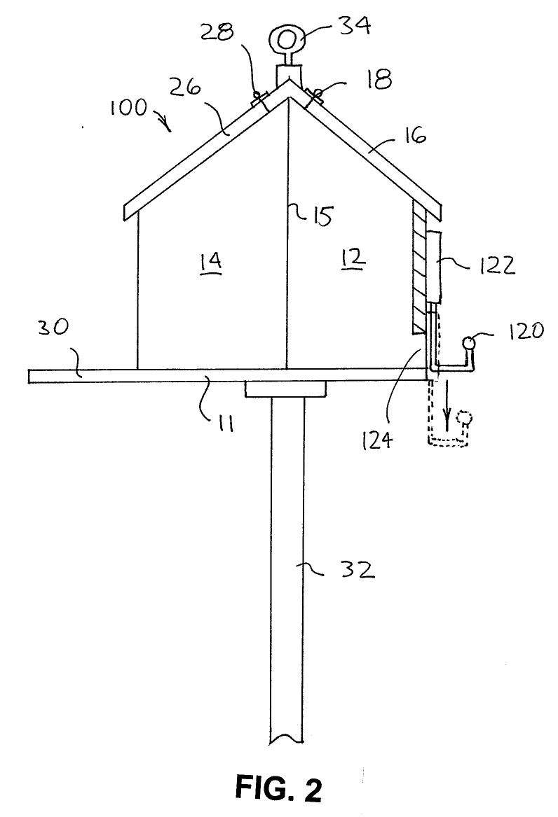

FIG. 2 shows another combined bird and squirrel feeder 100 in accordance with the present invention. The feeder 100 shown in FIG. 2 is similar to the feeder 10 shown in FIG. 1, but squirrels are prevented from eating the birdseed from the bird feed compartment 12. As used herein, the word “prevented” means that squirrels are completely or partially prevented from gaining access to the bird feed. A bird perch 120 is connected to a slidable door 122. When birds land on the bird perch 120, they are not heavy enough to lower the door 122, and the birds are allowed access to the birdseed in the bird feed compartment 12 through a lower opening 124. If a squirrel or other heavy animal attempts to eat from the bird feed side, their weight pushes the bird perch 120 downward to close the door 122, e.g., against the force of a spring (not shown) that biases the door 122 in the open position. In this manner, squirrels and other heavy animals are prevented from eating the birdseed contained in the bird feed compartment 12.

In addition to the slidable door shown in FIG. 2, any other suitable type of squirrel-deterring mechanism may be provided on the bird feeder side. For example, weight-sensitive bird perches such as those disclosed in U.S. Pat. Nos. 4,541,362, 5,309,867, 5,676,089, 5,720,238, 5,921,201, 6,561,128, 6,584,932, 6,591,781 and 6,918,353 may be used in accordance with the present invention. Furthermore, squirrel deterrent mechanisms such as those disclosed in U.S. Pat. Nos. 5,361,723, 5,490,480, 6,269,771 and 6,604,487 may be used in accordance with the present invention.

Whereas particular embodiments of this invention have been described above for purposes of illustration, it will be evident to those skilled in the art that numerous variations of the details of the present invention may be made without departing from the invention as defined in the appended claims.

1. A combined bird feeder and squirrel feeder comprising:
a bird feed compartment structured and arranged to hold bird feed and to allow birds access to the bird feed; and
a squirrel feed compartment adjacent to the bird feed compartment structured and arranged to hold squirrel feed and to allow squirrels access to the squirrel feed.

2. The combined bird feeder and squirrel feeder of claim 1, further comprising means for preventing squirrels from eating the bird feed from the bird feed compartment.

3. The combined bird feeder and squirrel feeder of claim 1, wherein the bird feed compartment and the squirrel feed compartment are separated from each other by a divider.

4. The combined bird feeder and squirrel feeder of claim 3, wherein the divider comprises a substantially vertical wall between the bird feed and squirrel feed compartments.

5. The combined bird feeder and squirrel feeder of claim 1, wherein the bird feed compartment and the squirrel feed compartment are located horizontally next to each other.

6. The combined bird feeder and squirrel feeder of claim 5, further comprising a base which forms a floor of the bird feed compartment and the squirrel feed compartment.

7. The combined bird feeder and squirrel feeder of claim 5, further comprising a roof covering the bird feed compartment and the squirrel feed compartment.

8. The combined bird feeder and squirrel feeder of claim 7, wherein the roof comprises means for filling the bird feed compartment and/or the squirrel feed compartment.

9. The combined bird feeder and squirrel feeder of claim 8, wherein the filling means comprises a hinged section of the roof over the bird feed compartment and another hinged section of the roof over the squirrel feed compartment.

10. The combined bird feeder and squirrel feeder of claim 1, further comprising a bird perch adjacent to the bird feed compartment.

11. The combined bird feeder and squirrel feeder of claim 10, wherein the bird perch is weight sensitive.

12. The combined bird feeder and squirrel feeder of claim 1, further comprising a squirrel ledge adjacent to the squirrel feed compartment.

13. The combined bird feeder and squirrel feeder of claim 1, further comprising means for mounting the feeder on a pole.

14. The combined bird feeder and squirrel feeder of claim 1, further comprising means for hanging the feeder.

15. The combined bird feeder and squirrel feeder of claim 1, wherein the bird feed has a smaller average particle size than the squirrel feed.

16. The combined bird feeder and squirrel feeder of claim 1, wherein the bird feed comprises sunflower seeds and/or millet, and the squirrel feed comprises nuts.

17. A combined bird feeder and squirrel feeder comprising:
a bird feed compartment including means for feeding birds from the bird feed compartment; and
a squirrel feed compartment adjacent to the bird feed compartment including means for feeding squirrels from the squirrel feed compartment.

18. The combined bird feeder and squirrel feeder of claim 17, further comprising means for preventing squirrels from eating the bird feed from the bird feed compartment.

19. The combined bird feeder and squirrel feeder of claim 18, wherein the means for preventing squirrels from eating the bird feed comprises a weight-sensitive perch.

20. The combined bird feeder and squirrel feeder of claim 17, wherein the bird feed compartment and the squirrel feed compartment are located horizontally next to each other and are separated by a substantially vertical divider.
